(19) United States
(12) Patent Application Publication
(10) Pub. No.: US 2012/0159326 A1
(43) Pub. Date: Jun. 21, 2012

(54) RICH INTERACTIVE SAGA CREATION

(75) Inventors: Vijay Mital, Kirkland, WA (US); Oscar E. Murillo, Redmond, WA (US); Darryl E. Rubin, Duvall, WA (US); Colleen Griffiths Estrada, Medina, WA (US)

(73) Assignee: Microsoft Corporation, Redmond, WA (US)

(21) Appl. No.: 12/969,672

(22) Filed: Dec. 16, 2010

(51) Int. Cl. G06F 3/01

(52) U.S. Cl. 715/716

(57) ABSTRACT

One or more techniques and/or systems are disclosed for creating a saga from signal-rich digital memories. User-related content, such as media elements and/or other signals, are captured and used to generate a digital memory graph, comprising the captured user-related content and associated metadata. An interactive saga of digital media elements is created using the digital memory graph by combining at least a portion of a plurality of digital media elements, from the captured user-related content, based on one or more user interactions.

### BACKGROUND

In a computer-related environment, people use various devices to capture various digital media (e.g., video, image, audio) for later viewing and/or listening experiences. Often, a user will collect a plurality of images and organize them in a folder on a device for later viewing, such as in a desired sequence, or related to a particular event (e.g., vacation). Further, some users may arrange their images in a type of slideshow presentation, for example, where images are viewed in a desired sequence that has been pre-arranged (or randomly generate) by the user. Additionally, different kinds of media may be combined into media experiences, such as combining several images in a collage, mixing in some preferred music, and adding animations and/or video.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

People often collect memories (e.g., recordings of experiences) in digital form, which can range from recording voices, archiving photographs and videos, and even recording some or all web sites or other digital assets they visit or see, for example. These users commonly view or revisit digital memories by navigating from stored digital memory to stored digital memory, such as among nodes in a graph of memories. Sometimes the navigation is overlaid with simple views, for example, where photo memories are navigated one photo at a time, or by views depicted as photo walls. These nodes are typically traversed along desired time lines, or by subject tags applied by the user to the stored digital memory.

However, as memories (e.g., digital representations of user experiences) get richer, such as by having multiple pieces of information recorded at the same time (e.g. respective experiences recorded by multiple sensors/cameras/viewpoints) merged together, node navigation or timeline or subject tag filtering may produce a confusing, unwatchable and/or difficult to understand experience. Currently, there may be no way for a user to combine a plurality of content captured by the user or others in a manner that provides for a rich interactive experience, such as where the user may change viewpoints or perspectives at a particular chosen point in the navigation of one or more memories, for example.

Accordingly, one or more techniques and/or systems are disclosed that provide an ability to take multiple portions of captured user-related content and combine them into one or more rich interactive sagas. For example, a digital memory graph can be created that organizes content, such as media content and signal content collected by device sensors, by some metadata associated with the content. The sagas can be synthesized based on user input, such as themes, perspectives, etc, where each alternate saga for a digital memory graph can be a set of rich multimedia scenes with visuals, audio, video and data obtained from spatial, biometric, ambient and/or other signals, for example.

In one embodiment for creating a saga from signal-rich digital memories, a digital memory graph is created that comprises captured user-related content (e.g., media elements) and associated metadata (e.g., relationships between respective media elements). The digital memory graph is used to generate an interactive saga of digital media elements. Generating the interactive saga comprises combining at least a portion of a plurality of digital media elements, respectively comprising user-related content, based on one or more user interactions.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an exemplary method for creating a saga from signal-rich digital memories.

FIG. 2 is a flow diagram illustrating one embodiment where one or more portions of a method for creating a saga from signal-rich digital memories are implemented.

FIG. 3 is a flow diagram illustrating one embodiment where one or more portions of a method for creating a saga from signal-rich digital memories are implemented.

FIG. 4 is a component diagram of an exemplary system for creating a saga from signal-rich digital memories.

FIG. 5 is a component diagram illustrating one embodiment where one or more systems described herein may be implemented.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A method may be devised that provides for synthesizing an interactive saga, comprising a set of rich (multi)media scenes, from a digital memory graph. The digital memory graph can comprise captured content along with associated metadata that describes or further defines the content, for example, relative to a time, person, event, etc. The captured content can be combined into the saga, and the saga can be altered, for example, by selecting a different perspective, time, person, theme, etc. In this way, for example, images, video, audio and/or other sensory information captured by sensors, for example, can be combined with animation that provides a rich, dynamic, interactive saga for a user to experience (e.g., revisit recorded or captured prior experiences).

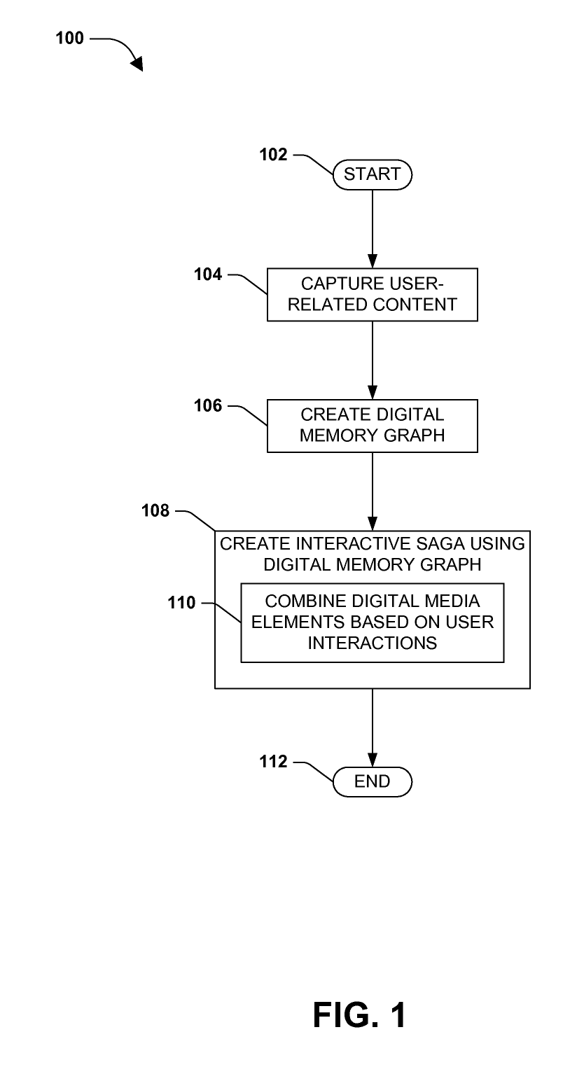

FIG. 1 is a flow diagram of an exemplary method 100 for creating a saga from signal-rich digital memories. The exemplary method 100 begins at 102 and involves capturing user-related content, at 104. For example, there are a variety of devices that may be used to capture video, images, audio and/or other sensory content. Often, sensors used to capture this type of content are incorporated into mobile devices (e.g., smart phones, media devices, portable computing devices), and/or are used in public and private devices (e.g., security cameras, web-cams, event cameras).

Further, other information may help describe, define and/or capture the user-related content. For example, a variety of sensors in a variety of devices and/or locations may be used to capture other information, such as: location (e.g., using GPS and/or signal triangulation, etc.); environmental conditions (e.g., using thermometer, weather info, and/or moisture detection, etc.); motion (e.g., using an accelerometer, GPS, and/or altimeter, etc.); biometrics (e.g., using pulse monitor, heart-rate monitor, breathing monitor, thermometer, and/or brain scan, etc.); and time. Additionally, user-related content can comprise information about captured media input by a user, such as an annotation, and/or some descriptive information (e.g., name, and/or location, etc.). Alternatively, or in addition to the foregoing, captured user-related content may also comprise information that has been mined from a resource, such as the Internet, and/or derived from some operation on already captured media and/or information.

At 106 in the exemplary method 100, a digital memory graph is created, using the captured user-related information. For example, a graph can comprise nodes and edges, where nodes can comprise an element from a set of elements, and the edges can identify some relationship between nodes. In this way, as an example, the nodes may comprise captured media content, and/or signals that help to further define captured media content, and the edges can comprise information that identifies how two nodes may be related (e.g., by time, person, place, event, capture device, etc.). For example, two different images of the same person taken at or about the same point in time, but taken from different perspectives may comprise two nodes where the nodes are connected by an edge because they are of the same person.

At 108, an interactive saga of digital media elements is generated using the digital memory graph. Creating the interactive saga of digital media elements comprises combining at least a portion of a plurality of digital media elements based on one or more user interactions, where the digital media elements comprise the user-related content. For example, different images of an event, video clips of the event, audio information related to the event, etc. acquired within a coincident time period, for example, can be collated in different manners (e.g., depending upon user interaction, instruction, etc. at 110) to provide different depictions of the event, for example. In this manner, the captured content can be used to create sagas from captured media and/or signals, where a user may be able to do more than just passively watch (or listen to) the presentations, for example, but may also determine what they were doing at a certain time, and/or what others were doing, seeing, feeling, from different viewpoints, times, locations, etc.

For example, a family may take a trip, where they use various digital devices to capture digital memory information of the trip. Later, when reviewing the memories of the trip (e.g., including video, audio, etc.) they may want to focus on a particular aspect of the trip. For example, they may want to create a saga that focuses on “the most thrilling moment” of the trip. In this example, when generating the saga, certain cues can be identified in index information associated with the captured digital media. Biometrics may identify times when one or more of the family members had elevated pulse rates; an accelerometer may identify when one of the family was moving fast (e.g., on a rollercoaster); and visual cues may be identified that can signal information corresponding to a thrilling experience.

Further, in this example, excerpts can be retrieved from the captured media content, cross-referenced for family members, time, location, etc. using the digital memory graph, and assembled into a montage of respective times when someone in the family was experiencing something that matched a “thrilling” moment. Additionally, the combination of digital media elements can be edited, and combined with some animation features to provide a smooth saga of thrilling moments for the trip, which may be experienced using some playback feature. While experiencing the playback, for example, one of the family members may wish to view a different perspective (e.g., what another family member was doing or experiencing at that time), and can redirect the saga by applying some additional criteria (e.g., interacting with the saga). In this example, the appropriate information can be identified using the digital memory graph, and an alternate sage can be generated to accommodate the user interaction.

Having created the interactive saga using the digital memory graph, the exemplary method 100 ends at 112.

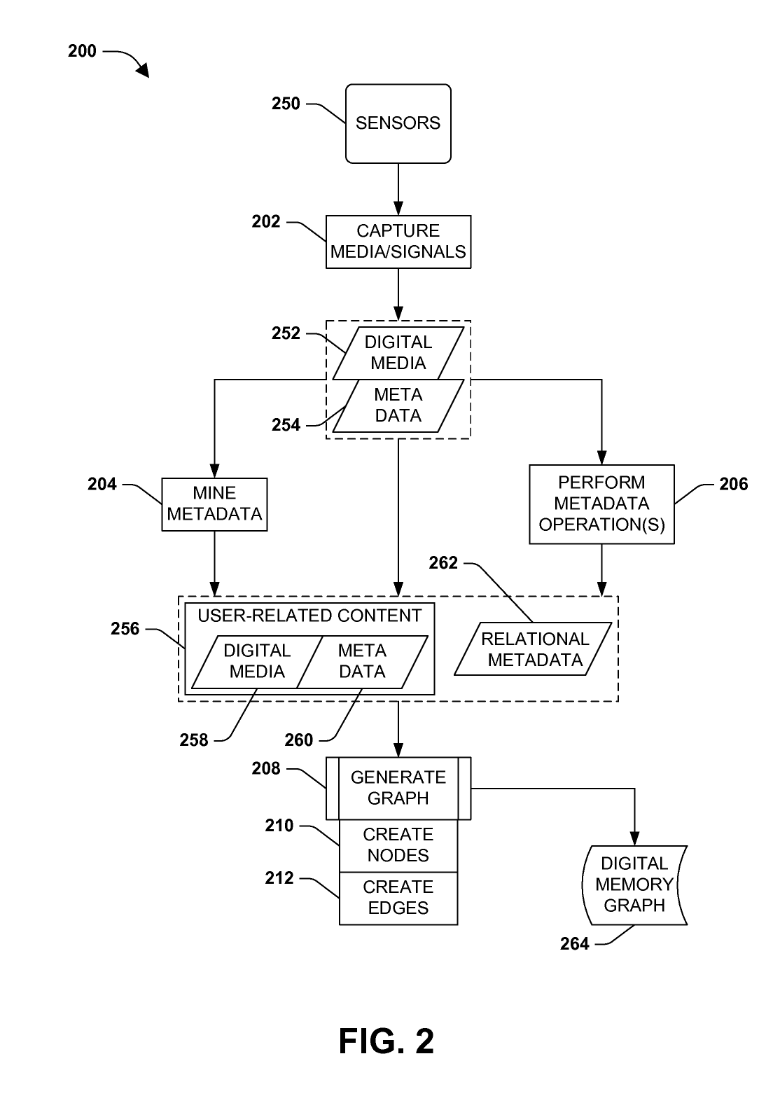

FIG. 2 is a flow diagram illustrating one embodiment 200 where one or more portions of a method for creating a saga from signal-rich digital memories are implemented. At 202, one or more sensors 250 can be used to capture media and/or signals. In one embodiment, captured user-related content can comprise digital media content 252 captured by the sensor(s) 250. Further, the captured user-related content can comprise metadata 254 related to the captured digital media content 252.

It can be appreciated that current personal mobile devices (e.g., smart phones, media devices, portable computing devices, cameras, etc.) collect a variety of digital media and signal information associated with the digital media. For example, a digital camera can collect images, audio and video media, along with a time signal, a location signal (e.g., GPS enabled), a user signal (e.g., indicating who is using the device), and/or a subject signal (e.g., indicating a subject of the image capture for facial recognition). As another example, as well as digital media collecting sensors, smart phones often comprise additional sensors, such as accelerometers, GPS sensors, and can be enabled to collect information from other sensors, such as biometrics, environmental, and/or touch, for example.

The type of user-related information captured can be generally grouped into two categories, active collection (e.g., when a user activates a video capture), and ambient (or passive) collection (e.g., when a location of the camera is collected by a GPS enabled sensor during an image capture) for example. In one embodiment, the captured user-related content can comprise a signal that is captured continuously by a sensor during a desired user event. For example, whether or not a user actively collects media (e.g., takes a picture), a sensor in their personal digital capture device may have a sensor that operates continually (e.g., accelerometer) that is collecting signal data ambiently. Further, as an example, a way that the user-related information is captured can be associated with a first user (e.g., when the first user collects the info), with a second user (e.g., when another collects information about the first user), and/or with a third party (e.g., a street monitoring camera capturing an image of the first user).

In one embodiment, the digital media content 252 captured by the sensor(s) 250 can comprise image, video, audio, and/or sensory information (e.g., touch data collected by pressure sensors, olfactory data collected by sniffers, taste data collected by chemical analysis sensors). Further, the metadata 254 associated with captured digital media content can comprise information captured at a same time as the captured digital media content 252. For example, as described above, sensors can capture signals in conjunction with the capture of the digital media elements, and signals can comprise information that helps further define or describe the media, such as a time, place, person, action, type of device, etc. In this embodiment, these captured signals can comprise at least some of the metadata associated with the captured digital media content.

In one embodiment, metadata 260 associated with captured digital media content used for creating a digital memory graph can be derived directly from the capture (e.g., at 202), along with the digital media content 258, which comprises the user-related content 256. In one embodiment, the metadata 260 associated with captured digital media content 258 used for creating the digital memory graph can also comprise information input by a user. For example, the user may wish to add an annotation to an image, video, etc. to further describe something about the captured media (e.g., a description of a subject of the image, what was happening at the time of the capture, etc.).

Additionally, at 206, the metadata 260 related to captured digital media content can comprise information identified by an operation, such as applied to the captured digital media 252. For example, image recognition operations (e.g., using a computer program) can be applied to a video or image to help identify a subject in the image, or even a location of the capture. As another example, a speech recognition operation can be applied to an audio media element to determine what is being said during the capture.

In one embodiment, at 204, the metadata 260 related to captured digital media content can comprise information indentified by an operation, such as applied to information input by a user related to the captured digital media content, and/or information retrieved from an online service related to the captured digital media content. For example, the user may input a person's name, or a building's name for information related to an image or video. In this example, the name can be looked up in a database (e.g., mined) to determine additional information for the captured media, such as a location of the building, other images that comprise the same person, etc. Further, as an example, information identified for the captured media content may be used to look up related information online, such as using a social network, online search engine, image gallery, etc., and such retrieved information and/or information related thereto (e.g., IP address) can be used as additional metadata related to the captured digital media content.

In this example embodiment 200, the information used to create the digital memory graph can comprise the user-related content 256, comprising captured digital media content 258 and metadata 260 related to the captured digital media content 258. In one embodiment, the user-related content may comprise merely content captured by the sensors. Further, the user-related content may comprise information mined from another source, such as the Internet or some database, for example, including additional images, video, audio, etc. Additionally, the user-related content may comprise information identified by some operations; or may comprise a combination of these.

The information used to create the digital memory graph can also comprise associated relational metadata 262, which may be derived from captured signals, operations, and/or mined, etc. and can describe a relationship between different user-related content. For example, if two images were captured at a same time, by different devices, and different users, this information may be used as relational metadata 262 to describe the relationship between the two images (e.g., same time, different people, and different devices).

At 208, the digital memory graph 264 can be generated. In one embodiment, the digital memory graph 264 can comprise a directed graph, for example, where nodes of the graph can comprise captured user-related content, and edges can comprise information that identifies a relationship between two nodes, such as relational metadata 262 for example. When generating the graph 264, at 210, a node can be created that indicates captured user-related content, such as one or more digital media elements, and/or metadata related to captured digital media content, as described above. At 212, one or more edges can be created between two nodes, where the edge indicates a user-related content capture relationship between the two nodes. For example, the edge in the graph may indicate that the two nodes comprise content that happened at a same location, was acquired at the same time or within a particular timeframe, etc.

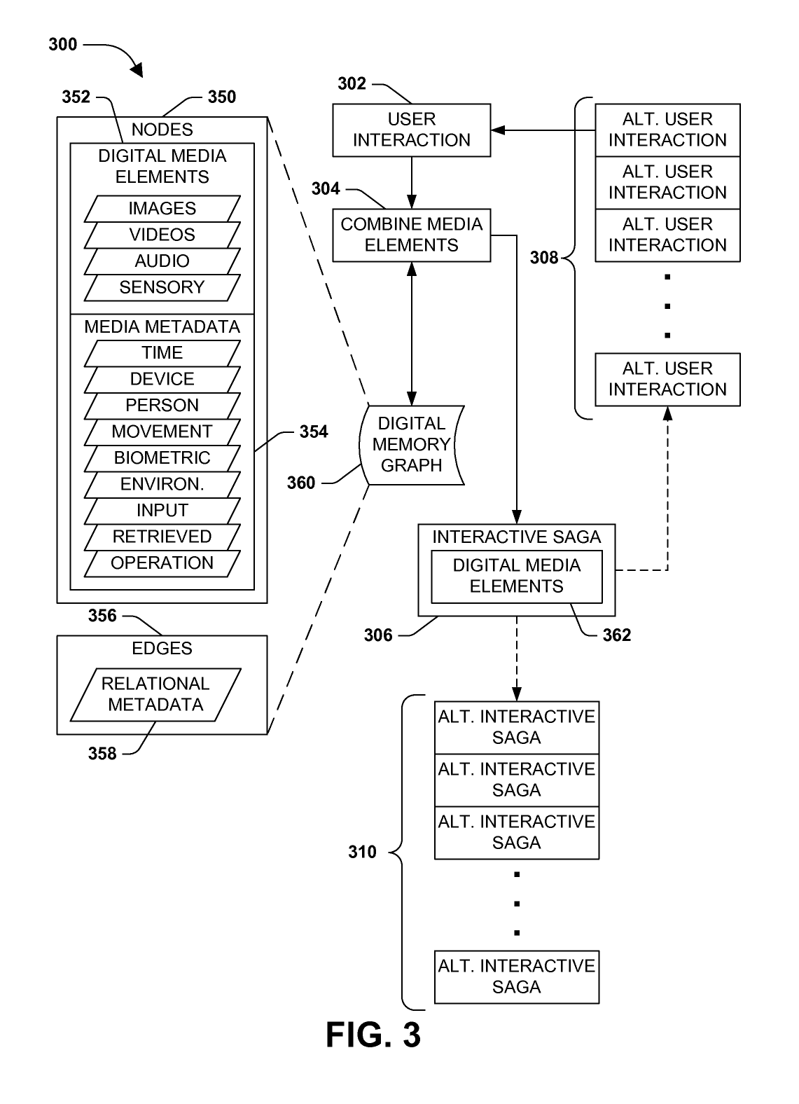

FIG. 3 is a flow diagram illustrating one embodiment 300 where one or more portions of a method for creating a saga from signal-rich digital memories are implemented. At 302, a user can decide on how an interactive saga may be generated by some interaction. In one embodiment, the user may select a saga theme, a saga perspective, one or more digital media types for the saga, and/or a timeline for the saga, etc.

As an example, for a family that returned from a trip with a plurality of collected media and signals from their trip, the theme of “the most thrilling moments” can be selected to generate an interactive saga comprising media that retells these most thrilling moments from the trip. Further, the family may decide to experience the “most thrilling moments” from a perspective of all of the family members, or merely one or two members. Additionally, in this example, the family may wish to include images, video and audio from the trip when creating the “most thrilling moments” saga; and they may wish choose a timeline that merely comprises a period of time when they were at a theme park during the trip.

At 304 in the example embodiment 300, digital media elements 352 can be combined for the generation of the interactive saga. In one embodiment, at least a portion of the plurality of digital media elements 352 can be combined, which can comprise selecting at least a portion of a first digital media element (e.g., portion of video clip taken by a first family member during a particular event), and identifying at least a portion of a second digital media element (e.g., portion of video clip taken by second family member during the event) to combine with the first digital media element. For example, the digital memory graph 360 can comprise nodes 350 that indicate user-related content, such as the digital media elements 352 and/or metadata 354 associated with the digital media, as described above. Further, the digital memory graph 360 can comprise edges 356, which may comprise associated relational metadata 358, such as metadata that indicates a user-related content capture relationship between the two nodes (e.g., time, individual, event, etc.).

In one embodiment, when combining digital media elements, identifying the second digital media element (or portion thereof) to combine with the first digital media element (or portion thereof), the selection can be based on a user-related content capture relationship between the first digital media element and the second digital media element, and/or on a relationship between metadata related to the first digital media element and metadata related to the second digital media element. For example, images can be selected to be combined where the images are acquired from a same device, and/or taken at a same or sequential time, for example.

For example, the family may decide to create the saga involving the most thrilling moments from the visit to the theme park from a perspective of the father and son, comprising audio, video and images. In this embodiment, for example, a first image may comprise a picture of the father and son getting on a rollercoaster taken by the mother. Further, based on a timing relationship identified by the relational metadata 358, a video of the pair on the coaster taken by a theme park camera mounted on the coaster car may be identified as next in the timeline, and combined in sequence with the image taken by the mother. Further, while riding the coaster, the son may have recorded a video, with audio, of the father. The timeline and location relationship identified by the relational metadata 358, using the media metadata 354 (e.g., time acquire), for the son's video can be used to concurrently combine the son's video with the video from the theme park camera (e.g., picture in picture, side by side, etc.). Thus, the saga may comprise the picture taken by mom collated with the videos take by the park and the son.

In another embodiment, the identifying of at least a portion of a second digital media element to combine with the first digital media element can be based on a user interaction comprising a user-selected preference for the interactive saga. For example, selecting two media elements (or portions thereof) to combine (e.g., either sequentially or concurrently) can be directed by an initial user interaction (e.g., or subsequent user interaction). In this example, the theme, such as “the most thrilling moments” can help identify those media elements to combine, such as two elements that occurred when the father had an elevated pulse rate or was moving at a high rate of speed. Moreover, where more than two media elements are available, user interaction may narrow the list to merely two elements.

In one embodiment, the interactive saga can be generated using the digital memory graph to determine an arrangement of the digital media elements by applying the one or more user interactions to the captured user-related content 352, 354 and associated relational metadata 358 in the digital memory graph 360. Applying the one or more user interactions to the captured user-related content and associated relational metadata can comprise identifying first captured user-related content, such as a first image taken at a particular place, that corresponds to the user interaction (e.g., location preference), and combining the user interaction (e.g., location preference) with the associated relational metadata to identify second captured user-related content (e.g., a second image from the same place). In this embodiment, for example, the relational metadata can be comprised in an edge that points to the second captured user-related content in a directed graph, comprising the digital memory graph 360. That is, for example, the two images or corresponding nodes may be connected or linked because they relate to the same location, and they may be ordered in the saga based upon metadata associated therewith that indicates respective times that the images were acquired, for example.

At 306 in the example embodiment 300, the interactive saga is generated, comprising the digital media elements 362. It will be appreciated that the interactive saga is not limited to any particular embodiment of combined media elements. For example, in one embodiment, the saga can comprise a montage of one or more digital media elements, such as combined images, videos, audio elements, and/or other elements. For example, other elements can comprise sensations created to mimic a theme or action in the interactive saga, such as smells, movement, and applied theatrical elements (e.g., lighting, water spray, air jets, etc.).

Other embodiments of the digital media elements may comprise a collage of a plurality of objects identified in a plurality of user-related content. For example, a same person (or people) (e.g., or scenery, buildings, etc.) may be identified in several media elements, then clipped from, and edited to one or more media elements to create a collage. Further, in some embodiments, the digital media elements may comprise a transition between a first saga viewpoint and a second saga viewpoint, such as provided by some created animation, blending, and/or fading, etc.

In another embodiment, the digital media elements or rather saga thereof may comprise a navigable immersive environment, such as a three-dimensional environment. As an example, several images, videos, etc. can be combined and blended or animated to create the three-dimensional environment, which the user may navigate through (e.g., interact with) to identify different perspectives for the interactive saga, for example. Further, the digital media elements may comprise animated elements, and/or hyperlinkable elements, such as to create transitions, and/or links to other themes, perspective, viewpoints, etc. for the saga.

In one embodiment, at 308, one or more alternate user interactions can be applied to the digital memory graph to generate respective alternate interactive sagas 310. For example, multiple different interactive sagas may be generated from a same digital memory graph 360. As an illustrative example, the family may view the created interactive saga from a “primary” viewpoint, comprising a composite of everyone's most thrilling moments of the trip. In this example, at any point during the viewing, they may wish to view the saga from a particular perspective, viewpoint, apply a different theme, artistic alteration, foundation, and/or other formulation of the events. In this way, for example, while watching the saga they may identify a particularly interesting event that they wish to view from the daughter's viewpoint. Accordingly, user interaction may be received to provide the daughter's viewpoint, at 308, which can create an alternate sage 310, comprising the daughter's viewpoint for the desired time and/or event, for example.

A system may be devised that creates an interactive saga of rich media content using a digital memory graph. User-related content can be captured, along with metadata that can be used to define the content, for example. The captured content can be combined into the saga, and the saga can be interactive, for example, by selecting alternate themes or perspectives. In this way, for example, images, video, audio and/or other sensory information captured by sensors, for example, can be combined with animation that provides a rich, dynamic, interactive saga for a user to experience.

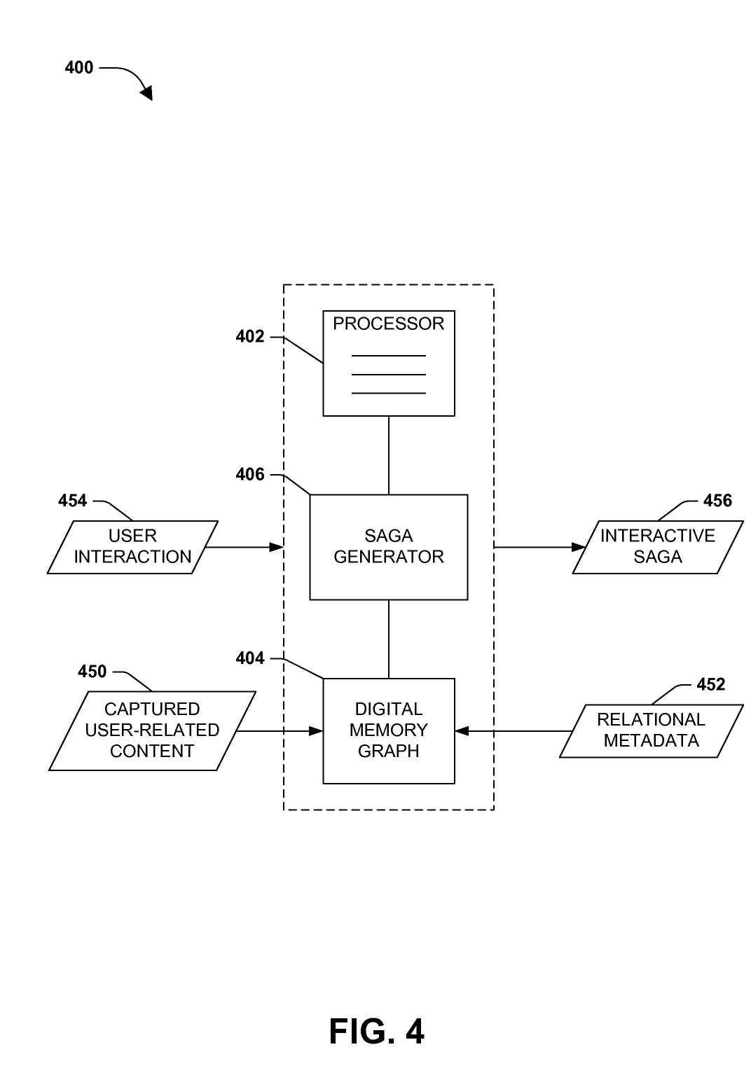

FIG. 4 is a component diagram of an exemplary system 400 configured to create a saga from signal-rich digital memories. A computer-based processor 402 is configured to process data for the system 400. A digital memory graph 404 organizes captured user-related content 450 using associated metadata, such as relational metadata 452 in a directed graph. For example, the directed graph of the digital memory graph 404 can be made up of nodes, comprising the captured user-related content (e.g., digital media elements and/or metadata for the elements), and edges, comprising relational metadata (e.g., how the nodes are related to each other, such as by time, location, etc.).

A saga generation component 406 is operably coupled with the processor 402 and the digital memory graph 404. The saga generation component 406 is configured to generate one or more interactive sagas 456 of digital media elements using the digital memory graph 404. The saga generation component 406 combines at least a portion of a plurality of digital media elements, comprising the user-related content 450 from the digital memory graph 404, based on one or more user interactions 454 with the saga generation component 406. For example, the combination of digital media elements identified from the digital memory graph 404 can be determined by a user theme choice, perspective choice, media choice, etc.

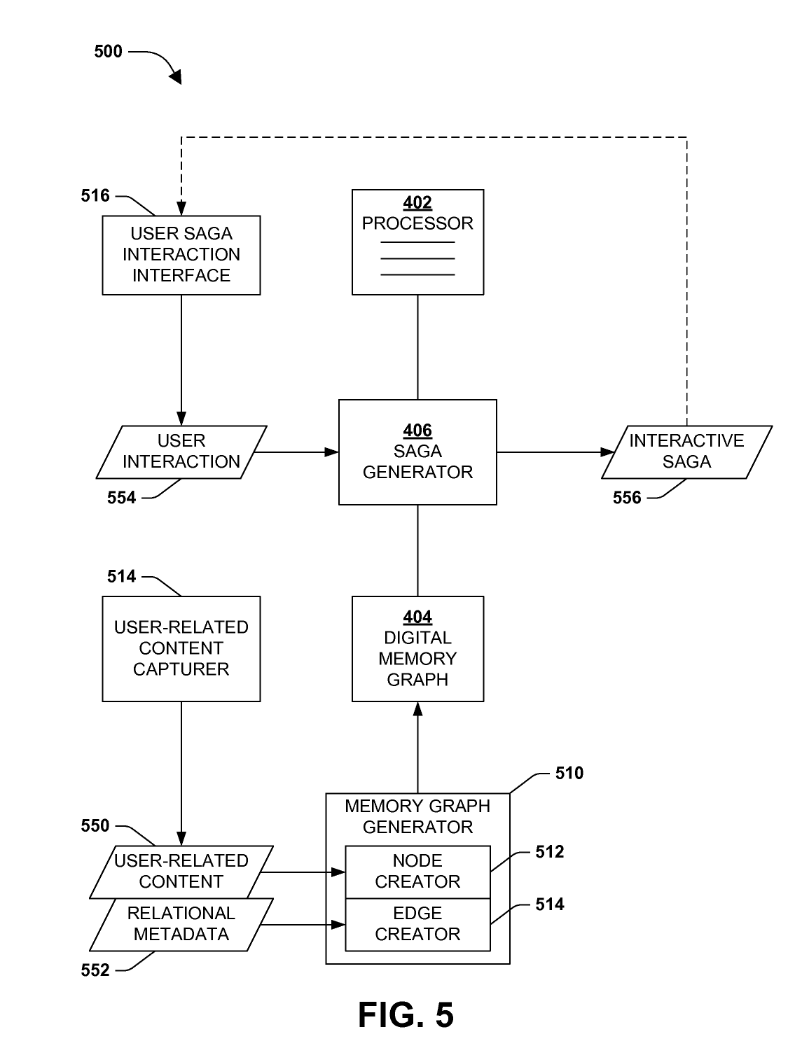

FIG. 5 is a component diagram illustrating one embodiment 500 where one or more systems described herein may be implemented. A digital memory graph generation component 510 is configured to generate the digital memory graph 404. The digital memory graph generation component 510 can comprise a node creation component 512 configured to create a node for the digital memory graph 404, where the node comprises an indication of captured user-related content 550. Further, the digital memory graph generation component 510 can comprise an edge creation component 514 configured to create one or more edges between two nodes for the digital memory graph 404, where respective edges comprise an indication of a user-related content capture relationship between the two nodes (e.g., captured at a same time, place, of a same person, building, during a same event, etc.), such as from relational metadata 552, for example, associated with the user-related content 550.

A user-related content capture component 514 captures user-related content 550 for the digital memory graph 510. In this embodiment, the user-related content can comprise digital media content 550 that has been captured by a sensor, such as images, video, audio, sensory information, time, location, movement, biometrics, environmental conditions, and/or other signals that may be identified (e.g., actively or passively). Further, the captured content may be actively captured by one or more users for one or more events (e.g., using a camera), and/or ambiently (passively) captured, such as by a sensor that is continually monitoring user activity (e.g., GPS, accelerometer, etc,)

Additionally, the user-related content can comprise metadata 552 related to the captured digital media content 550, where at least some of the metadata may (or may not) provide and/or be used to provide an indication of a relationship between different user-related content (e.g., acquired at the same time, of the same individual, of the same event, etc.). In one embodiment, the metadata 552 related to captured digital media content 550 can comprise information captured by a sensor at a same time as the captured digital media that further defines captured digital media 550. For example, when a user snaps a photo, the camera may also collect a location of the camera (e.g., GPS enabled), a time of the photo, the photographer, and even a subject of the photograph. The metadata 552 related to captured digital media content 550 can also comprise information input by a user concerning captured digital media, such as an annotation describing the subject of the content.

In one embodiment, the metadata 552 related to captured digital media content 550 can comprise information retrieved from an online service related to the captured digital media content, and/or information generated by applying captured digital media to an operation. For example, the user-related content capture component 514 may be used to retrieve information from the Internet or some database using a search operation for a subject, place, image retrieval, etc. Further, as an example, the user-related content capture component 514 may be used to apply an operation to captured data, such as identifying a same person from one image in a plurality of other images or videos. In this way, additional information may be identified for the captured content, for example, and used as metadata by the memory graph generator 510 to further define the content in the digital memory graph 404.

A user saga interaction component 516 can comprise a user interface (UI), and provide for a user to interact with the saga 556. In this embodiment, when the user uses the UI to interact with the saga 556, for example, the interaction can determine how the plurality of digital media elements (or portions thereof) are to be combined, such as by the saga generation component 406 (operatively coupled to a processor 402 configured to process data for the system). For example, the user may utilize the user saga interaction interface component 516 to decide a theme, perspective, viewpoint, type of media etc. for the desired saga. The user interaction 554 can be used by the saga generation component 406 to generate the interactive saga 556, which may subsequently be interacted with by the user, such as at a desired moment in the saga, to change the saga to a desired alternate saga, for example.

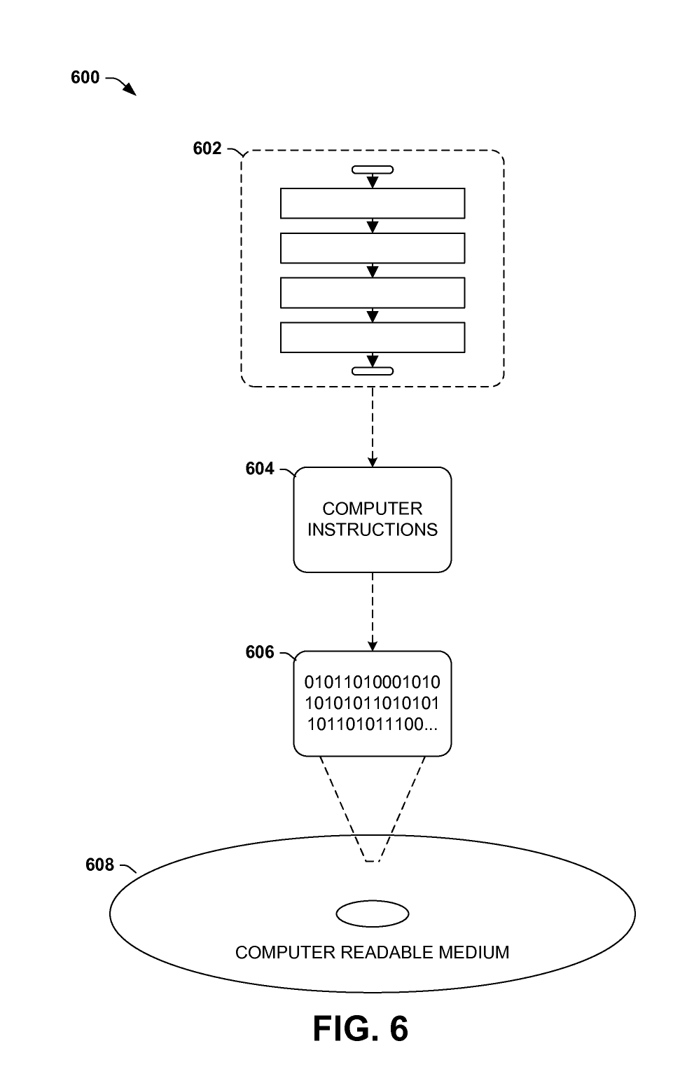

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 608 (e.g., a CD-R, DVD-R, or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as at least some of the exemplary method 100 of FIG. 1, for example. In another such embodiment, the processor-executable instructions 604 may be configured to implement a system, such as at least some of the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

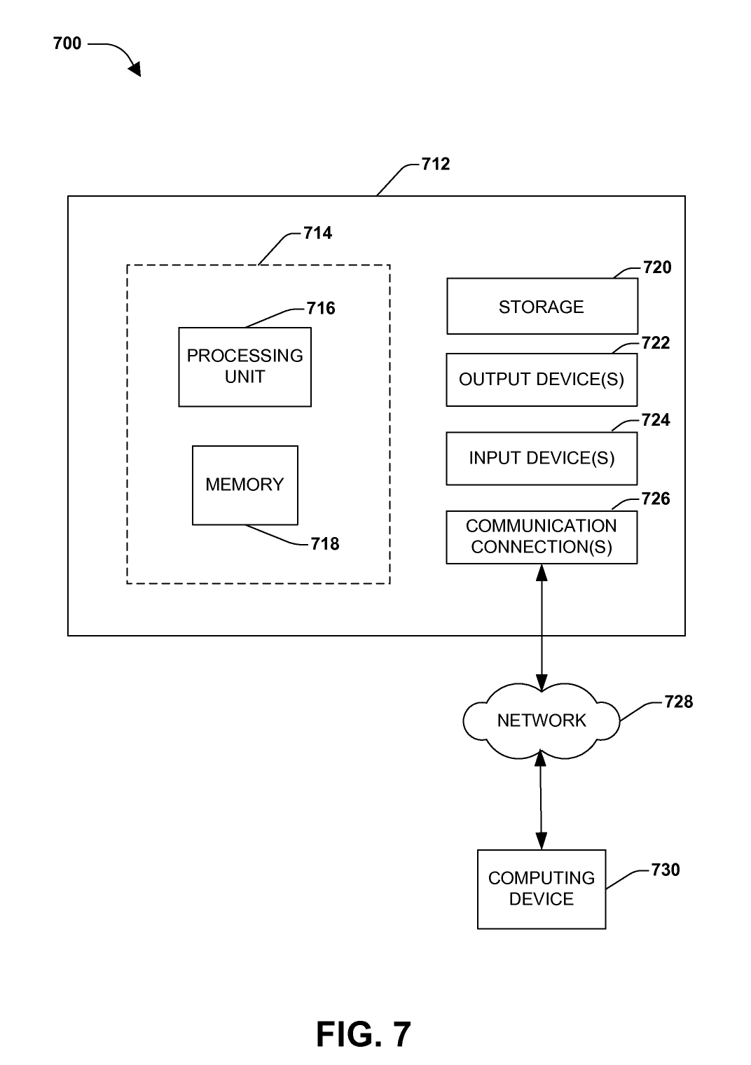

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A computer-based method for creating a saga from signal-rich digital memories, comprising:
generating an interactive saga of digital media elements using a digital memory graph comprising captured user-related content and associated metadata, using a computer-based processor, the generating the interactive saga comprising combining at least a portion of a plurality of digital media elements, comprising the user-related content, based on one or more user interactions.

2. The method of claim 1, comprising generating the digital memory graph, comprising generating a directed graph.

3. The method of claim 2, generating the digital memory graph comprising:
creating a node that indicates captured user-related content; and
creating one or more edges between two nodes, where respective edges indicate a user-related content capture relationship between the two nodes.

4. The method of claim 1, the captured user-related content comprising digital media content captured by one or more sensors.

5. The method of claim 4, the metadata comprising one or more of:
information captured at a same time as the captured digital media content;
information input by a user;
information retrieved from an online service related to the captured digital media content; and
information identified by an operation applied to one or more of:
the captured digital media content;
information input by a user related to the captured digital media content; and
information retrieved from an online service related to the captured digital media content.

6. The method of claim 1, the captured user-related content comprising a signal captured continuously by a sensor during a desired user event.

7. The method of claim 1, the combining at least a portion of the plurality of digital media elements comprising:
selecting at least a portion of a first digital media element; and
identifying at least a portion of a second digital media element based on one or more of:
a user-related content capture relationship between the first digital media element and the second digital media element;
a relationship between metadata associated with the first digital media element and metadata associated with the second digital media element; and
a user interaction comprising a user-selected preference for the interactive saga.

8. The method of claim 1, the combining at least a portion of the plurality of digital media elements comprising one of:
combining a first digital media element with a second digital media element sequentially in the interactive saga; and
combining a first digital media element with a second digital media element concurrently in the interactive saga.

9. The method of claim 1, the combining at least a portion of the plurality of digital media elements based on one or more user interactions comprising using one or more of the following user interactions to perform the combining:
user selection of a saga theme;
user selection of a saga perspective;
user selection of one or more digital media types; and
user selection of a timeline.

10. The method of claim 1, the generating the interactive saga using the digital memory graph comprising determining an arrangement of the digital media elements by applying the one or more user interactions to the captured user-related content and associated metadata in the digital memory graph.

11. The method of claim 10, applying the one or more user interactions to the captured user-related content and associated metadata comprising:
identifying first captured user-related content that corresponds to a first user interaction; and
combining the first user interaction with metadata associated with the identified first captured user-related content to identify second captured user-related content.

12. The method of claim 1, comprising applying one or more alternate user interactions to the digital memory graph to generate an alternate interactive saga.

13. The method of claim 1, digital media elements comprising one or more of:
a transition between a first saga viewpoint and a second saga viewpoint;
a collage of a plurality of objects identified in a plurality of user-related content;
a montage of one or more digital media elements;
a navigable immersive environment;
an animated element; and
a hyperlinkable element.

14. A system for creating a saga from signal-rich digital memories, comprising:
a computer-based processor configured to process data for the system;
a digital memory graph configured to organize captured user-related content using associated metadata in a directed graph; and
a saga generation component operably coupled with the processor and digital memory graph, and configured to generate an interactive saga of digital media elements using the digital memory graph by combining at least a portion of a plurality of digital media elements, comprising the user-related content from the digital memory graph, based on one or more user interactions with the saga generation component.

15. The system of claim 14, comprising a digital memory graph generation component configured to generate the digital memory graph.

16. The system of claim 15, the digital memory graph generation component comprising:
a node creation component configured to create a node for the digital memory graph that comprises an indication of captured user-related content; and
an edge creation component configured to create one or more edges between two nodes for the digital memory graph, where respective edges comprise an indication of a user-related content capture relationship between the two nodes.

17. The system of claim 14, comprising a user-related content capture component configured to capture user-related content for the digital memory graph, where the user-related content comprises digital media content captured by a sensor.

18. The system of claim 17, the metadata comprising one or more of:
information captured at a same time as the captured digital media content;
information input by a user;
information retrieved from an online service related to the captured digital media content; and
information generated by applying the captured digital media content to an operation.

19. The system of claim 14, comprising a user saga interaction component comprising a user interface, and configured to provide for user interaction with the saga, where the user interaction determines the combining of the at least a portion of a plurality of digital media elements.

20. A computer-based method for creating a saga from signal-rich digital memories, comprising:
capturing user-related content comprising one or more of:
digital media content captured by a sensor; and
metadata associated with captured digital media content, the metadata associated with captured digital media content comprising one or more of:
information captured at a same time as the captured digital media content;
information input by a user;
information retrieved from an online service related to the captured digital media content; and
information identified by a lookup operation applied to the captured digital media content;
generating a digital memory graph, comprising generating a directed graph, comprising:
creating a node that indicates captured user-related content; and
creating one or more edges between two nodes, where respective edges indicate a user-related content capture relationship between the two nodes; and
generating an interactive saga of digital media elements using the digital memory graph, using a computer-based processor, the generating of the interactive saga comprising combining at least a portion of a plurality of digital media elements, comprising:
selecting at least a portion of a first digital media element; and
identifying at least a portion of a second digital media element based on one or more of:
a user-related content capture relationship between the first digital media element and the second digital media element;
a relationship between metadata associated with the first digital media element and metadata associated with the second digital media element; and
a user interaction comprising a user-selected preference for the interactive saga.
